(19) United States
(12) Patent Application Publication
(10) Pub. No.: US 2016/0157979 A1
(43) Pub. Date: Jun. 9, 2016

(54) REPRODUCTIVE STATUS INDICATION SYSTEM AND METHOD

(71) Applicant: FARMSHED LABS LIMITED, Hamilton (NZ)

(72) Inventors: Bartel Christiaan Dinger, Hamilton (NZ); Fraser Michael Smith, Hamilton East (NZ)

(73) Assignee: Farmshed Labs Limited, Hamilton (NZ)

(21) Appl. No.: 14/906,541

(22) PCT Filed: Jul. 23, 2014
(86) PCT No.: PCT/NZ2014/000152

§ 371 Date: Jan. 20, 2016

(30) Foreign Application Priority Data
Jul. 23, 2013 (NZ) 613532

(51) Int. Cl. A61D 17/00

(52) U.S. Cl. CPC A61D 17/002; A61D 17/006

(57) ABSTRACT

The invention relates to a reproductive status indication system that comprises an electronic sensing device placed on a bovine, wherein the device is adapted to detect the bovine's reproductive activity and produce reproductive activity data based on that activity. The reproductive status indication system also comprises a data processing system, which analyses the data according to a preselected reproductive activity threshold and time threshold to make a determination as to whether or not the bovine is likely pregnant, following a breeding event, and to cause the reproductive status indication system to provide a visual indication of whether or not the bovine is pregnant, based on that determination.

### FIELD OF THE INVENTION

The invention relates to a system and method for providing a reproductive status indication for bovines.

### BACKGROUND TO THE INVENTION

In the context of dairy cows, efficient dairy production relies on getting cows pregnant within the tightest time window possible. A failure to achieve pregnancy in the cow usually results in lost milk supply. Likewise, in the context of beef cows, efficient beef production relies on getting cows pregnant within the tightest time window possible. A failure to achieve pregnancy in beef cows results in lost time available for weight gain prior to slaughter. Most dairy cows and an increasing number of beef cows these days are artificially inseminated. The timing of the artificial insemination is based on monitoring the oestrus or heat cycle of each cow to predict the cow's ovulation time (i.e. when the cow is in oestrus or in heat).

There are four types of reproductive status that are important for farmers in decision-making and that directly impact on the profitability of a farm. In particular, it is important for the farmer to know:
1. The oestrus status of a cow so that the farmer can determine when to inseminate the cow;
2. Whether a cow is pregnant or non-pregnant (in which case the cow may be re-inseminated when she is next in oestrus);
3. Whether a cow has abnormally short oestrus cycles, which may suggest that she has polycystic ovaries; and
4. Whether a cow is non-cycling, indicating a failure to enter a normal reproductive pattern to become capable of getting pregnant.

It is particularly important for a farmer to know which of the cows in the herd that have been bred (e.g. artificially inseminated or inseminated by bull) do not become pregnant. The sooner the farmer knows that a cow has not become pregnant following artificial insemination, the sooner the cow can be resubmitted for a subsequent round of insemination at the next oestrus cycle in order to try and minimise further economic losses from the cow being non-pregnant.

Currently, there is no reliable way for a farmer to identify a non-pregnant cow prior to the next oestrus cycle, which typically occurs every 20-23 days. Typically, pregnancy confirmation following breeding is carried out by trained technicians using ultrasonography or rectal palpation, which is time consuming and expensive. Determining that a cow is non-pregnant using ultrasonography or rectal palpation is only possible after the first possible opportunity for re-submitting the cow for a further insemination round has passed at circa 21 days. In particular, ultrasound for pregnancy diagnosis may only be reliably carried out as early as 25 days after insemination by using highly skilled technicians, and is more typically carried out after 35 days. Rectal palpation for pregnancy diagnosis is only reliable from as early as 30 days from insemination in heifers and from 35 days in cows.

It is also important for a farmer to know as soon as possible whether a cow is pregnant so that the farmer can ensure that the cow is not inseminated again while pregnant. Insemination of a pregnant cow is not only a waste of semen but often results in miscarriage.

In addition, it is important for a farmer to be able to identify cows having an abnormal oestrus cycle, which can indicate reproductive problems. If these problems can be identified and corrected, fertility may be restored giving the cow the best chance of getting pregnant following breeding. If not, the cow may be culled.

Getting a cow's reproductive status wrong and/or failing to identify cows with reproductive problems can result in significant losses to the farmer.

It is an object of the invention to provide a system and/or method for providing an early indication of a cow's reproductive status or to at least provide the public with a useful choice.

### SUMMARY OF THE INVENTION

In one aspect, the invention provides a reproductive status indication system for generating an indication of a female bovine's reproductive status, the system comprising: an electronic sensing device for locating on a bovine, the device comprising a detection assembly that is adapted to detect reproductive activity or absence of activity associated with the bovine and to produce reproductive activity data relating to the reproductive activity; and a data processing system configured to receive reproductive activity data and analyse the reproductive activity data with respect to at least one predetermined reproductive activity threshold and at least one predetermined time threshold and to determine the bovine's reproductive status based on the analysis of the reproductive activity data; wherein the reproductive status indication system is adapted to provide a visual indication of whether or not the bovine is pregnant after the bovine has undergone a breeding event, the visual indication being provided at or subsequent to the time at which the bovine is next expected to be in oestrus if she does not conceive, and wherein the visual indication provided is based on the determination produced by the data processing system.

Optionally, the reproductive status indication system is also adapted to provide a visual indication of whether or not the bovine has an undetermined reproductive status after the bovine has undergone a breeding event and before the time period in which the bovine is next expected to be in oestrus.

Optionally, the reproductive status indication system is also adapted to provide a visual indication of whether or not the bovine is in oestrus.

The reproductive status indication system may also comprise a breeding event indicator to indicate whether or not the bovine has been inseminated within a predetermined time period.

Preferably, the data processing system analyses the reproductive activity data using data processing software configured to automatically change the at least one predetermined reproductive activity threshold and/or the at least one predetermined time threshold after the data processing system determines that the cow is in oestrus. Preferably, the thresholds are changed by adjusting the specificity and/or sensitivity to reproductive activity data, which may be data obtained within a time period corresponding to the oestrus cycle of the bovine and/or data that has been obtained over a longer time period.

The reproductive status indication system of any preceding claim, wherein the data processing system analyses the reproductive activity data using data processing software configured to automatically decrease the at least one predetermined reproductive activity threshold and/or the at least one predetermined time threshold after the data processing system determines that the cow is exhibiting low reproductive activity analogous to quiet oestrus.

Optionally, the data processing system is adapted to receive secondary data from one or more other devices, wherein the secondary data is indicative of whether the bovine is in oestrus or not.

The reproductive status indication system may also be adapted to provide visual alert that indicates that the bovine has a reproductive problem. Preferably, the visual alert is configured to indicate any of the following reproductive problems: that the bovine has an abnormally short oestrus cycle; that the bovine has poly-cystic ovaries; that the bovine is anoestrus; or that the bovine has conceived but has then miscarried.

Preferably, the sensing device is adapted to detect both behavioural indicators of reproductive activity and physiological indicators of reproductive activity.

Optionally, the sensing device comprises an accelerometer.

Preferably, the data processing system is adapted to disregard any false reproductive activity data, such as bumps.

Preferably, the reproductive status indication system is adapted to measure the time and duration of reproductive activity and/or to identify patterns of data correlated with reproductive activity.

Optionally, the sensing device is adapted to provide a visual indication of the bovine's reproductive status. Preferably, the sensing device comprises one or more lights, such as LEDs, that are adapted to provide a visual indication of a bovine's reproductive status by being any two or more of the following: lit, unlit, flashing, and/or changing colour.

Alternatively, the data processing system is an external data processing system separate to the sensing device and further comprising: a data gatherer for receiving the reproductive activity data from the sensing device; a bovine identification data reader for reading identification data associated with the bovine; and a data processor configured to: receive and analyse the reproductive activity data from the data gatherer with respect to a predetermined reproductive activity threshold and a predetermined time threshold; receive identification data for the bovine from the bovine identification data reader; and determine the bovine's reproductive status based on the analysis of the reproductive activity data.

Optionally, the reproductive status indication system is adapted to communicate with and control mechanical drafting gates for sorting bovines having a different reproductive status.

In another aspect, the invention provides a method of providing a visual indication of a bovine's reproductive status, the method carried out by a reproductive status indication system and comprising: placing an electronic sensing device on a bovine to detect reproductive activity associated with the bovine; producing reproductive activity data based on the detected reproductive activity; providing a data processing system to receive reproductive activity data from the sensing device; analysing the reproductive activity data to determine the reproductive status of the bovine; and providing a visual indication of whether or not the bovine is pregnant after the bovine has undergone a breeding event, the visual indication being provided at or subsequent to the time at which the bovine is next expected to be in oestrus if she does not conceive, and wherein the visual indication provided is based on the determination produced by the data processing system.

Preferably, the method further comprises the step of providing secondary data relating to a bovine's reproductive status to the data processing system, wherein the data processing system analyses the reproductive activity data and secondary data to determine the reproductive status of the bovine.

Preferably, the method further comprises the step of generating a visual alert if the reproductive activity data, over a predetermined time period, indicates that the bovine has abnormal reproductive status. Preferably, the visual alert is generated if the reproductive activity data shows that:
a) the bovine has an abnormally short oestrus cycle;
b) the bovine is anoestrus and does not come into oestrus within the predetermined time period;
c) within the predetermined time period, the reproductive status indication system provided an indication that the bovine was pregnant and then subsequently provided an indication that the bovine is non-pregnant due to miscarriage.

In another aspect, the invention provides a reproductive status indication system for generating an indication of a female bovine's reproductive status, the system comprising: an electronic sensing device for locating on a bovine, the device comprising a detection assembly that is adapted to detect reproductive activity or absence of activity associated with the bovine and to produce reproductive activity data relating to the reproductive activity; and a data processing system configured to receive reproductive activity data and analyse the reproductive activity data with respect to at least one predetermined reproductive activity threshold and at least one predetermined time threshold and to determine the bovine's reproductive status based on the analysis of the reproductive activity data; wherein the reproductive status indication system is adapted to provide a visual indication of whether or not the bovine is in oestrus or not, wherein the visual indication provided is based on the determination produced by the data processing system; and wherein the reproductive status indication system is adapted to provide visual alert that indicates that a bovine has a reproductive problem.

In all forms of the invention, the bovine is preferably a cow.

In another aspect, the invention broadly consists in a method of generating a reproductive status indication for a cow, the method carried out by a data processing system and comprising: receiving electronic reproductive activity data sensed by an electronic reproductive activity indicator onboard the cow; analyzing the received reproductive activity data to determine the oestrus status of the cow; and generating a reproductive status indication based on the determined oestrus status of the cow, wherein the electronic reproductive activity data is received by the data processing system subsequent to a breeding event associated with the cow.

Optionally, the method further comprises initially receiving a start input signal, and commencing the remaining method steps in response to the start input signal. The start input signal may be generated automatically by the data processing system or manually triggered by a user. The start input signal is typically indicative that a breeding event associated with the cow has occurred.

Optionally, the method further comprises receiving electronic data indicative of a breeding event associated with the cow. In one form, the data indicative of the breeding event comprises data indicating that the cow has been bred, for example subjected to artificial insemination or inseminated by bull. Additionally, the data may comprise the time of insemination.

The method may further comprise calculating and storing the expected time the cow would be in oestrus in the next oestrus cycle.

Optionally, the method comprises generating a reproductive status indication selected from one of the following: undetermined, pregnant, or non-pregnant. The method may comprise the step of generating a reproductive status indication of undetermined when a negative oestrus status is detected prior to a time threshold.

Optionally, the method comprises generating a reproductive status indication of pregnant when a negative oestrus status is detected on or after a time threshold, or in a predetermined time window associated with the time threshold. By way of example, the time window may be centered about the time window or off-centered, or offset from the time threshold.

Optionally, the method comprises generating a reproductive status indication of non-pregnant when a positive oestrus status is detected. Preferably, the method may further comprise generating supplementary non-pregnancy data associated with the non-reproductive status indication based on the time relative to the time threshold. In one example, the method may comprise generating supplementary non-pregnancy data indicative of cow reproductive problems (e.g. possible ovarian cyst) if a positive oestrus status is detected prior to the time threshold. In another example, the method may comprise generating supplementary non-pregnant data indicative of unsuccessful insemination/conception if a positive oestrus status is detected on or about the time threshold or in a time window associated with the time threshold. In another example, the method may comprises generating supplementary non-pregnancy data indicative of probable miscarriage or lost pregnancy if a positive oestrus status is detected after the time threshold and if a reproductive status indication of pregnant has previously been generated. For example, the method may further comprise continuing to monitor the reproductive activity data subsequent to generating a reproductive status indication of pregnant for a predetermined time period.

Optionally, the method comprises periodically receiving a batch of reproductive activity data from the onboard reproductive activity indicator, and generating an updated reproductive status indication based on each new received batch of reproductive activity data. By way of example, the method may comprise receiving a daily batch of reproductive activity data. Each batch of reproductive activity data may comprise data indicative of one or more sensed mountings or no mountings that have occurred in a time period. The time period may be uniform or vary, depending on the frequency at which the batches of reproductive activity data are received from the reproductive activity indicator.

Preferably, the reproductive activity data comprises data indicative of the time and duration of each mount sensed. The time may be the real time or the time relative to a reference time that the mount occurred.

Preferably, the detecting of the oestrus status of the cow is based on whether a sequence of mountings are clustered within a certain time interval. By way of example, detecting a positive oestrus status is based on the reproductive activity data satisfying a predetermined threshold. For example, the predetermined threshold may relate to a predetermined minimum number of heat mounts occurring within a predetermined time interval. In one example, the predetermined threshold is in the range of at least three heat mounts within about four hours and four heat mounts in less than about three hours.

Optionally, the step of generating a reproductive status indication comprises presenting reproductive status data indicative of the cow's reproductive status on a graphical user interface on a display of or associated with the data processing system and/or storing the reproductive status data on a storage device or database of or associated with the data processing system and/or sending the reproductive status data over a network to another electronic device or system.

Optionally, the method further comprises identifying the cow associated with the reproductive activity data being received. By way of example, the method may further comprise receiving identification data indicative of the identity of the cow associated with the received reproductive activity data. In one form, the identification data may be received from an electronic identification device (such as an electronic ID ear tag) attached to the cow, which is separate to the reproductive activity indicator. Preferably, the method may comprise receiving the identification data and reproductive activity data substantially simultaneously, and linking or creating a data association between the identification data and reproductive activity data based on the simultaneous reception.

Optionally, the method further comprises sending the received identification data to the electronic reproductive activity indicator.

Optionally, the method further comprises generating a reproductive status indication for a cow based on the determined oestrus status of the cow and one or more types of secondary data associated with the cow. By way of example only, the possible secondary data may comprise data indicative of any one or more of the following: milking order changes, changes in pedometry, changes in rumination time, changes in sitting & standing, changes in body temperature (internal, external and milk), hormone changes (such as progesterone, oestradiol, pregnancy associated glycoproteins, luteinizing hormone), milk yield changes, milk composition changes, and/or electrical impedance changes of vaginal mucus.

Optionally, the method may further comprise generating one or more control signals to control one or more mechanical drafting gates to sort each cow based on its reproductive status indication.

In a another aspect, the invention broadly consists in a data processing system for generating a reproductive status indication for a cow, the data processing system comprising a processor configured to: receive electronic reproductive activity data sensed by an electronic reproductive activity indicator onboard the cow subsequent to a breeding event associated with the cow; analyse the received reproductive activity data to detect the oestrus status of the cow; and generate a reproductive status indication based on the determined oestrus status of the cow.

In another aspect, the invention broadly consists in a computer-readable medium having stored thereon computer executable instructions that, when executed on a processing device, cause the processing device to perform a method of: receiving electronic reproductive activity data sensed by an electronic reproductive activity indicator onboard the cow subsequent to a breeding event associated with the cow; analysing the received reproductive activity data to detect the oestrus status of the cow; and generating a reproductive status indication based on the determined oestrus status of the cow.

In another aspect, the invention broadly consists in an electronic reproductive status indication device for placement on a female bovine, comprising: an electronic reproductive activity indicator configured to sense mounting activity associated with the bovine on which the device is mounted after a breeding event and generate indicative reproductive activity data; a data processor that is configured to: receive the sensed electronic reproductive activity data from the reproductive activity indicator; analyze the received reproductive activity data to determine the oestrus status of the bovine; and generate a reproductive status indication based on the determined oestrus status of the bovine; and a visual output indicator for generating a visual output indicative of the generated reproductive status indication.

In another aspect, the invention broadly consists in a method of automatically controlling one or more mechanical drafting gates to sort female bovines based on an indicative reproductive status indication, the method comprising: receiving electronic reproductive activity data sensed by an electronic reproductive activity indicator onboard the cow, subsequent to a breeding event associated with the bovine; analyzing the received reproductive activity data to determine the oestrus status of the bovine; generating a reproductive status indication based on the determined oestrus status of the bovine; and generating one or more control signals to control one or more mechanical drafting gates to sort each bovine based on its reproductive status indication.

To assist with understanding the invention, the following explanations and definitions are provided.

The phrase “sensing device” as used in this specification is intended to mean, unless the context suggests otherwise, any form of electronic sensor that is attached to a cow, typically on or in the vicinity of the tail ridge, that comprises a contact, pressure, or tactile sensor or switch, whether mechanical, electro-mechanical, or capacitance based, that is intended to be activated primarily in response to mounting activity in which the cow is mounted by another cow or bull when in standing heat, and which is typically configured to store and/or send electronic reproductive activity data corresponding to the time and duration of each instance of sensor or switch activation.

The term “reproductive status” as used in this specification is intended to mean, unless the context suggests otherwise, an indication of whether cow is in oestrus (i.e. in heat) or not. I.e. the presence or absence of the oestrus phase of the cow's oestrus cycle, based at least partly on analysis of the reproductive activity data sensed for the cow. The term is also used to mean an indication of whether the cow is pregnant, non-pregnant, or it is unknown whether she is likely pregnant or not. The term is also used to refer to abnormal oestrus cycles, such as the absence of oestrus or abnormal frequencies of oestrus cycles, which may indicate that a cow has reproductive problems.

The phrase “behavioural indicators of reproductive status” as used in this specification is intended to mean behaviours that a cow is in oestrus, such as mounting and deliberate close contact from other animals, such as nuzzling, chin and neck resting, licking, increased pedometry, and sniffing around the rump.

The phrase “physiological indicators of reproductive status” as used in this specification is intended to mean physical changes indicating that a cow is in oestrus, such as temperature increases associated with oestrus.

The phrase “oestrus status” as used in this specification is intended to mean, unless the context suggests otherwise, an indication of whether cow is in oestrus (i.e. in heat) or not. I.e. the presence or absence of the oestrus phase of the cow's oestrus cycle, based at least partly on analysis of the reproductive activity. The cow is is considered to be in oestrus whether the onset of oestrus is detected, peak oestrus is detected, or the end of the oestrus phase is detected.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

The term “indication” as used in the specification is intended to mean “likely”. For example, an indication that a cow is pregnant means that she is likely to be pregnant—it is not a conclusive determination that the cow is in fact pregnant.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1a is a perspective view of one form of sensing device according to the invention;

FIG. 1b is a side view of the sensing device of FIG. 2a

FIG. 2 is an exploded view of the sensing device of FIGS. 2a and 2b;

FIG. 3 is a schematic diagram of the main system components of a cow reproductive status indication system according to one embodiment of the invention;

FIG. 4 is a schematic diagram of one form of sensing device and data processing system according to the invention;

FIG. 5 is a block diagram of the main components of another form of sensing device and data processing system according to the invention;

FIG. 7a shows a timeline chart of sensed reproductive activity data in a first example scenario in which a cow is detected as being pregnant, but subsequently miscarries;

FIG. 7b shows a timeline chart of sensed reproductive activity data in a second example scenario in which a cow is detected as being non-pregnant and having reproductive problems;

FIG. 7c shows a timeline chart of sensed reproductive activity data in a third example scenario in which a cow is detected as being non-pregnant after insemination in a first oestrus cycle, but is subsequently detected as being pregnant after another round of insemination in the next subsequent oestrus cycle;

FIG. 8 is a flow diagram of the main data processing steps in determining the reproductive status indication of a cow according to an embodiment of the invention; and

FIG. 9 shows an example of a graphical user interface which provides a graphical representation of the reproductive status indication for cows being analysed in a herd.

### DETAILED DESCRIPTION OF PREFERRED EMBODIMENTS

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of some operations may be rearranged. A process is terminated when its operations are completed. A process may correspond to a method, a function, a procedure, a subroutine, a subprogram, etc., in a computer program.

Aspects of the systems and methods described below may be operable on any type of computer system or computing device, including, but not limited to, a desktop, laptop, notebook, tablet, or mobile electronic device.

1. Overview

The invention relates to a system and method for monitoring and automatically indicating the reproductive status of female bovines. In particular, the invention relates to a system and method for providing an early indication of whether or not a female bovine is pregnant after she has been inseminated (whether through artificial insemination or not).

The following example implementation of the reproductive status indication system is in the context of a dairy herd, but it will be appreciated that the system can be adapted to other bovine herds, including but not limited to beef cows, buffalo, and water buffalo.

The system is used for monitoring and indicating the reproductive status of cows in a herd by placing an electronic sensing device on each cow in the herd, or at least on those cows to be monitored. The sensing device detects reproductive activity associated with the cow to which the device is attached. In particular, the device is adapted to detect behavioural activity that indicates whether or not the cow is in oestrus (in heat). Optionally, the sensing device is also adapted to detect physiological activity that indicates whether or not the cow is in oestrus.

Based on the detected reproductive activity, the device produces reproductive activity data. This data is then processed using a data processing system that executes software that compare(s) the data with at least one preselected reproductive activity threshold and at least one preselected time threshold. The data processing system then makes a determination about the cow's reproductive status and causes the reproductive status indication system to produce a visual indication of the cow's reproductive status depending on that determination.

The reproductive activity data may be processed by a data processing system located on the device itself, which will then provide a visual indication of the cow's reproductive status. Alternatively, the data may be transmitted from the device or read from the device and processed by an external data processing system that is separate to the device. A data processor of the external data processing system makes a determination about the cow's reproductive status, as described above, and then causes the reproductive status indication system to provide a visual indication of the cow's reproductive status (such as by displaying its status on a graphical user interface) and/or the external data processing system may transmit the determination data back to the sensing device to cause the sensing device to provide a visual indication of the cow's reproductive status.

The reproductive status indication system is adapted to provide a visual indication that the cow's reproductive status is any one or more of the following: in oestrus, not in oestrus, pregnant, non-pregnant. Optionally, the system may also provide a visual indication that the cow's reproductive status is undetermined. For example, at the beginning of the breeding season, the system may indicate whether or not a cow is in oestrus. Additionally or alternatively, where a cow has been recently inseminated (i.e. has undergone a breeding event), the system may indicate that the cow is pregnant, non-pregnant, or that her reproductive status is undetermined if prior to the time of her next expected oestrus.

The visual indication that a cow is or is not in oestrus, is or is not pregnant, or has an undetermined reproductive status, may be a positive indication, such as the activation of a light, or text or a symbol that is displayed on a display screen, or the visual indication may be a silent indication, such as no signal. For example, the system may be configured so that no signal is provided if the system determines that a cow is not in oestrus and so that a positive indication is provided if the system determines that a cow is in oestrus.

Although the system does not provide a conclusive indication of a cow's reproductive status, it is able to provide a sufficiently reliable and early indication of her reproductive status to allow the farmer to make more accurate decisions relating to the insemination of individual cows than if the farmer were to visually monitor each cow's behaviour.

The device may be used as a decision making tool for the farmer. For example, a farmer will typically aim to have all cows in a herd pregnant as soon as possible in the breeding season so that the calves have plenty of time to gain weight before the winter and to maximise the milk yield from the cow. If a cow is not pregnant after a first breeding event, the farmer will want the cow to become pregnant as soon as possible (i.e. when she is next in oestrus). By providing a farmer with an indication of a cow's reproductive status, the farmer is better able to make decisions relating to the cow, particularly whether and when she is to be inseminated and, in a worse case scenario, whether or not she should be culled. For example:
(1) If the reproductive status indication system indicates that a cow is in oestrus, the farmer may decide to inseminate the cow.
(2) If the reproductive status indication system detects that a cow has not returned to heat (i.e. that the cow has a negative oestrus status) at the next expected oestrus cycle after a breeding event, then the system may produce a reproductive status indication of pregnant because a pregnancy will suppress further oestrus cycles from occurring. The farmer will then decide not to re-inseminate the cow. To be able to identify a pregnant cow at an early stage is important because to re-inseminate a pregnant cow, which often occurs where oestrus is suspected by observed behaviour but is incorrect (i.e. a false positive), carries a high risk of terminating the existing pregnancy.
(3) If the reproductive status indication system detects a cow returning to heat (i.e. that the cow has a positive oestrus status) after a breeding event, a reproductive status of non-pregnant is generated. In this situation, the device may also indicate that the cow is in oestrus and is therefore ready for re-insemination. To identify a non-pregnant cow at an early stage is also important because the farmer can re-inseminate the cow as soon as she is in oestrus, in the hope that she will then become pregnant.
(4) If the reproductive status indication system detects that a cow is returning to oestrus abnormally quickly (such as a cow with short oestrus cycles often caused by poly-cystic ovaries), or has returned to oestrus after recently receiving an indication that she was pregnant (such as a cow that has miscarried), or if the system finds that a cow is never in oestrus (anoestrus) (such as a cow that cannot conceive), or detects other abnormal reproductive characteristics, the system may produce a visual alert that indicates that the cow has an abnormal reproductive status that may be related to the cow having a reproductive problem. The farmer can then decide whether to treat the cow to correct the reproductive problem that is preventing pregnancy or cull the cow. Alternatively, in some forms of the invention, the farmer may adjust the system reproductive activity threshold and/or time thresholds used to be data processing system to suit the characteristics of the particular cow. For example, for cow with an unusually short inter oestrus interval, the farmer may reduce the time threshold of the data processing algorithm to better relate to that particular cow's oestrus cycles. Similarly, for cow's that exhibit quiet heat (low reproductive activity when in oestrus), the farmer may lower the reproductive activity threshold of the data processing software to reflect activity levels for that particular cow when in oestrus. The farmer may also alter the reproductive activity threshold.

Optionally, the data processing software used to determine the reproductive status can vary its sensitivity and specificity to reflect the number of heats and therefore the presumed number of breeding events that a cow has undergone in a breeding season in order to optimize outcomes. For example, at the start of the season, the cow is non-pregnant, so the reproductive activity threshold of the data processing algorithm may be quite low to capture all, or almost all, reproductive activity. In this form, the system has a high sensitivity to reproductive activity and may incorrectly indicate that a cow is in oestrus. If the device incorrectly identifies that a cow is in oestrus, the worst case scenario is that the farmer wastes a straw of semen (if artificial insemination is used). A wasted straw of semen is not particularly costly compared to the high cost of failing to identify a cow in oestrus. Therefore, in the first round of insemination, the system may be set up to risk producing a small number of incorrect indications that a cow is in oestrus to avoid the risk of failing to identify a cow that is in oestrus. However, if the system incorrectly indicates that a cow is in oestrus following a first or subsequent round of breeding, the result may be that an already pregnant cow is re-inseminated. This has a high risk of terminating the existing pregnancy with substantial economic cost and risk to the cow. To help avoid this and optimize outcomes, the data processing system may be reprogrammed, or it may default to a different program, such as a second tier program to be used after a breeding event, to raise the reproductive activity threshold so that only very clear instances of reproductive activity will meet the threshold. By adjusting the data processing system in this way, there is less risk that a costly mistake will result if the reproductive status indication system provides an incorrect indication of a cow's reproductive status.

The reproductive status indication system is configured to detect the reproductive status of a cow continuously or periodically for a predetermined time period. Typically, this time period starts at the beginning of the breeding season or just after a breeding event, in which a cow is inseminated. The time period may end at a predetermined time after the next expected oestrus cycle for the cow (which would only occur if breeding was not successful) or at a later time period.

The reproductive status indication system may also be useful in general farming practice. For example, the system may be connected to one or more mechanical drafting gates on the farm and may generate control signals for the control system or actuators of the gate(s) to move the gate(s) to automatically sort cows into particular holding pens, or paddocks, or to otherwise separate the cows based on their respective reproductive status indication.

2. System Components

The components of the reproductive status indication system will now be described in further detail.

### Sensing Device

The sensing device is adapted to be attached to a cow to sense reproductive activity associated with that cow. Typically, a sensing device is placed on each cow in a herd.

The sensing device comprises a base that supports a detection assembly for detecting reproductive activity associated with the cow. Typically, the device further includes a cap that is attached to the base so that the base and cap together form a housing in which the detection assembly is held.

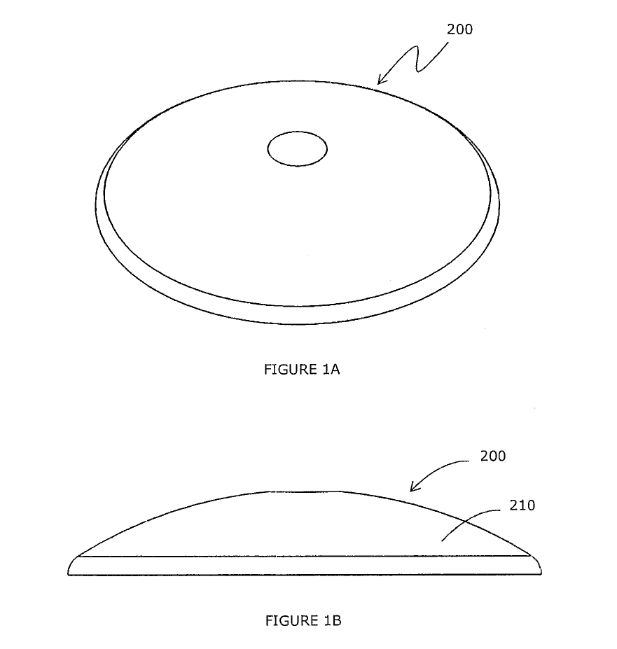

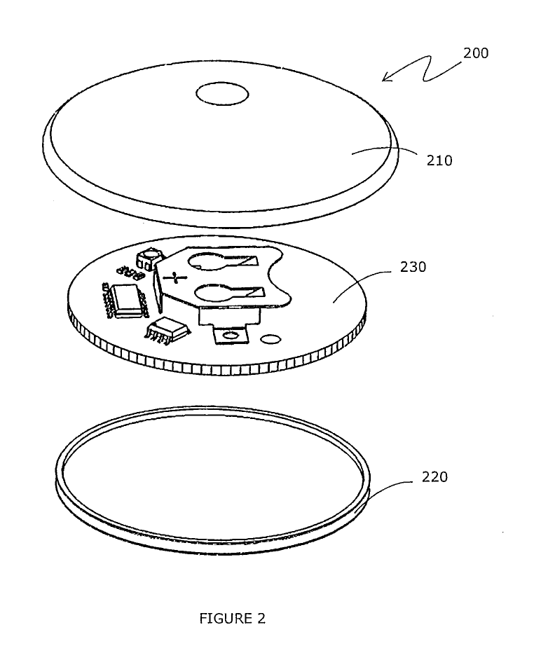

FIGS. 1a, 1b, and 2 show one form of sensing device 200 for use with the system of the invention. In this form, the device 200 comprises a cap 210 that is mounted on a base 220. The cap and base together form a housing within which a PCB 230 is held. Preferably, the cap is substantially dome-shaped and comprises a concave internal cavity for housing the PCB, but it should be appreciated that the cap may be of any suitable shape and size.

The base of the device is hermetically sealed against the cap to prevent water entering the cavity within which the PCB is held. Optionally, the seal is openable and re-sealable so that the PCB can be removed and replaced, if required.

The base of the device comprises a bottom surface that is adapted to receive an adhesive for attaching the device to the cow. However, it should be appreciated that the device can be attached to a cow using any suitable means for attachment.

Typically, the device is attached to the posterior region of a cow, such as on the tail ridge of a cow or an area proximate to the tail ridge, although it should be appreciated that the device may be located on the cow at any suitable area.

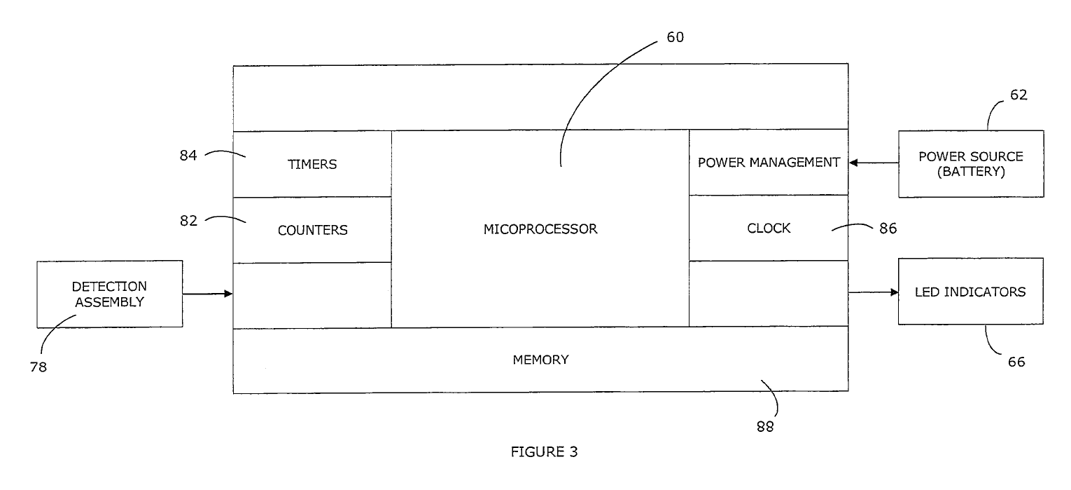

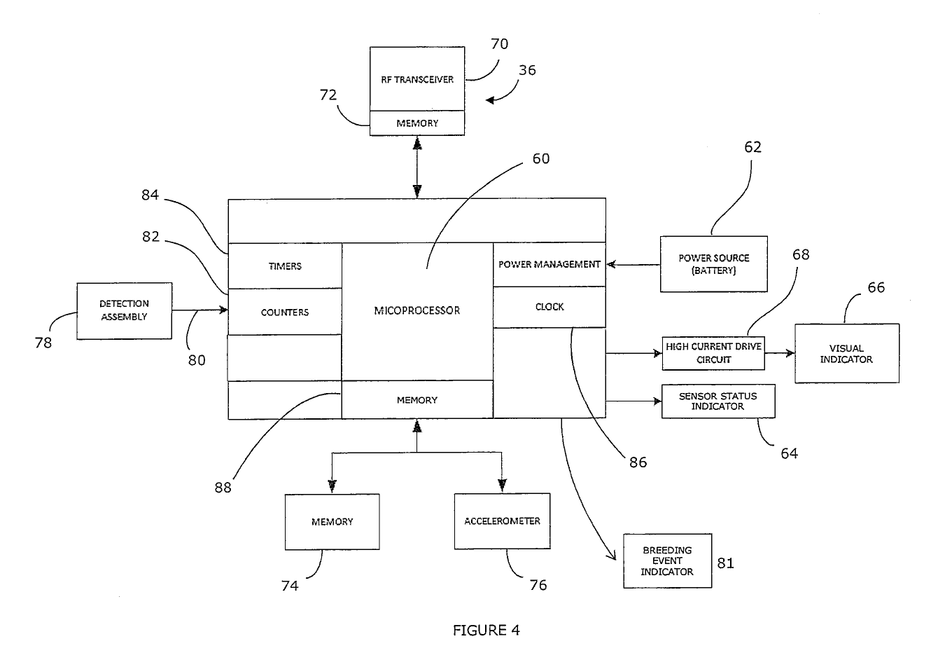

As shown in FIGS. 3 and 4, the device comprises a detection assembly 78 for sensing reproductive activity that indicates the onset of oestrus. In the embodiment illustrated in FIGS. 1a, 1b and 2, the detection assembly is mounted on the PCB.

The reproductive activity detected by the device includes behavioural activity associated with reproductive status. The behavioural activity includes mounting activity (when a cow is mounted by another cow or bull) and may also include one or more of the following: chin resting, nuzzling, licking, nudging, changes in pedometry, changes in rumination time, changes in sitting and standing, milking order changes (the sequence in which cows enter the dairy parlour), and any other behaviours that indicate that the cow is in oestrus. The device may also be configured to detect reproductive activity based on physiological activity associated with reproductive status, such as changes in body temperature (which may be changes in the cow's internal and/or external temperature).

The detection assembly 78 comprises one or more sensors for sensing reproductive activity associated with the cow. For example, the device may comprise any form of pressure, force, or touch sensor or switch, or one or more combinations of a mechanical switch, piezoelectric sensor, or capacitive touch sensor, that is/are activated by the pressure, force, or touch associated with mounting activity (where a cow is mounted by another cow or bull). The sensor(s) may also be used to sense other behavioural indicators of reproductive status, such as those described above. Additionally, the detection assembly may comprise near sensing technology for sensing the close presence of other cows or bulls. This technology may be particularly useful for sensing nudging, nuzzling, and licking by other cows or bulls. The detection assembly may also include a temperature sensor for sensing an increase in the body temperature of the cow, which often occurs when a cow is in heat. The detection assembly may also comprise an accelerometer for sensing movement and position of the cow.

As shown in the embodiments of FIGS. 3 and 4, the device also comprises a microprocessor 60, a power source 62, such as a battery, and preferably a sensor status indicator 64, such as a standard low power LED or similar, to indicate normal device operation and adequate battery level, such as by using flashing codes. Each of these components is preferably mounted on the PCB.

Every time a reproductive activity is sensed, the detection assembly generates an activation signal. The microprocessor 60 is configured to receive and process the activation signals 80 from the detection assembly 78 to produce reproductive activity data. Where the detection assembly comprises an accelerometer, the microprocessor is configured to analyse the accelerometer data to determine true reproductive activity, i.e. to filter out any false reproductive activity data, such as bumps.

The microprocessor preferably comprises counters 82, timers 84, and a clock 86 that are used to process the sensor activation signals to produce reproductive activity data relating to the time and duration of each mount or other detected reproductive activity. For example, in one form, the microprocessor is adapted to record the time interval between when mounts or other reproductive activity occurred, including the start and finish time of each mount or other reproductive activity. Preferably, the internal clock 86 of the microprocessor 60 is a real time clock so that the reproductive activity data is recorded in real time. Alternatively, the clock may record the time since the reproductive activity data was last read by or transmitted to a data gatherer. By recording the time at which reproductive activity occurred (i.e. at which the sensor was activated), the microprocessor is able to identify instances of reproductive activity that are close in time to each other (i.e. to identify clusters of reproductive activity), which is typically indicative of the cow being in oestrus. The reproductive activity data may be stored in an internal memory 88 of the microprocessor and/or an extended memory 74.

### Data Processing System

The reproductive activity data is processed by a data processing system running software that analyses the data according to at least one preselected reproductive activity threshold and at least one time threshold.

The data processing software, including the reproductive activity threshold and time threshold is preprogrammed into the data processing system. The data processing system processes the reproductive activity data by comparing the data to the reproductive activity threshold within a selected time period. In particular, the data processing system is programmed to make a determination that a cow is in oestrus or that a cow is pregnant, as the case may be, if the reproductive activity data satisfies the predetermined reproductive activity threshold and predetermined time period. Conversely, if the thresholds are not met, the device makes a determination that the cow is not in oestrus or is not pregnant.

The detection assembly and/or the data processing system may be adapted to measure the time and duration of reproductive activity and/or to identify clusters of reproductive activity to assist with the analysis and comparison of the reproductive activity data with the reproductive activity threshold and time threshold.

The predetermined reproductive activity threshold may relate to a predetermined number of heat mounts (where a cow is mounted by another cow or bull), the duration of the mounts, a predetermined increase in body temperature, a predetermined number of and/or duration of other behavioural or physiological indicators of reproductive status, or any combination of these indicators within a predetermined time interval. In one example, the predetermined reproductive activity threshold and time threshold is in the range of at least three heat mounts within about four hours and four heat mounts in less than about three hours. In another example, the predetermined thresholds are in the range of at least three heat mounts within about three hours and a body temperature of 0.5° C. above normal. However, it will be appreciated that other threshold ranges may be configured as desired.

The reproductive activity threshold and time threshold may be fixed thresholds, but preferably, the reproductive status indication system is adapted so that the thresholds can be readily changed to reflect the number of time that a cow has been in oestrus and therefore the presumed number of breeding events that the cow has undergone within the breeding season. The thresholds may be changed by reprogramming the system, either manually or wirelessly. Preferably, however, the software itself is configured to use different thresholds after each time that the data processing system determines that the cow is in oestrus. In this form, the software successively changes to a different tier of thresholds, each successive tier requiring a higher level of reproductive activity to satisfy the reproductive activity and time thresholds. For example, at the beginning of the breeding season, when the cow is clearly non-pregnant, the farmer wants to know if the cow is in oestrus and ready for breeding. The reproductive activity and time thresholds are set at a first tier, which is at a high level of sensitivity to detect any reproductive activity that indicates that a cow is in oestrus even if some cows are incorrectly identified as being in oestrus (false positive).Because the reproductive status indication provided by the system is indicative rather than conclusive, there is a risk that the system could incorrectly indicate that a cow is non-pregnant following a breeding event. To subject a pregnant cow to further insemination can expose the cow to a greater risk of miscarriage. Therefore, to reduce this risk, after the data processing system determines that the cow is in oestrus, the software changes to use a second tier of thresholds to determine when the cow is next in oestrus. The second tier of thresholds requires a higher level of reproductive activity (specificity) for the system to indicate that a cow is non-pregnant following a determination as to her oestrus status after a breeding event. The reproductive activity threshold and/or the time threshold used by the data processing software may be successively adjusted after each time that the data processing system determines that the cow is in oestrus (and therefore after each presumed breeding event, assuming that the farmer inseminates the cow when the system indicates that she is in oestrus). In this way, the system can optimize sensitivity and specificity to ensure the best outcomes.

In another example, the time threshold may be changed for cows that exhibit quiet heat/oestrus. In other words, the reproductive activity and/or time threshold may be lowered to better capture the reproductive status of a cow that exhibits a quiet heat. In this form, the data processing software is configured to identify that the cow has shown low levels of reproductive activity at around the same time of her oestrous cycles over a predetermined number of cycles; to recognize this low activity as reproductive activity analogous to heat but that does not meet the existing reproductive activity and/or time thresholds; and to adjust one or both thresholds to better identify when that particular cow is in oestrus.

After processing the reproductive activity data, the data processing system makes a determination as to the cow's reproductive status and the reproductive status indication system provides a visual indication of her reproductive status. The visual indication may be provided on the sensing device and/or on a separate graphical user interface, such as a computer screen, tablet, screen, smart phone screen, or the like.

The data processing system may be part of the sensing device or it may be an external data processing system separate from the sensing device.

### Data Processing System as Part of the Sensing Device

In one embodiment, as shown in FIG. 3, the reproductive activity data is processed by a data processing system that forms part of the sensing device. Typically, the microprocessor performs the function of a data processor for the data processing system. In this form, the microprocessor is programmed to process the reproductive activity data by using data processing software that analyses the data with respect to at least one preselected reproductive activity threshold and at least one preselected time period and to make a determination as to a cow's reproductive status, as described above. In other forms, a separate data processing system is provided on the device.

Preferably, the software is either re-programmable or automatically changes the reproductive activity threshold and/or the time threshold after each time that the data programming system determines that the cow is in oestrus. The sensing device may provide a user interface through which a user can reprogram the data processing system to alter these thresholds. Alternatively, the sensing device may be adapted to receive a replacement program with new thresholds from an external device. For example, the sensing device may be adapted to be reprogrammed through wireless communication with another device.

The sensing device may also comprise an extended memory module 74 to enable detailed data collection and analysis.

After the data processing system has made a determination as to the cow's reproductive status, the sensing device of the reproductive status indication system is caused to provide a visual indication 66 of that status, such as variable lights, LED's; an LCD display, or a screen display or the like of text, symbols, and/or colours to indicate different reproductive status. The reproductive status indication may be updated in real time as new reproductive activity data is sensed.

In one form, the sensing device comprises one or more lights, such as LEDs, that are used to provide a visual indication 66 of a cow's reproductive status. For example, an LED may flash a green light to indicate that a cow is in oestrus. The device may exhibit no light to indicate that a cow is not in oestrus. A red flashing light may be used to indicate that a cow is likely pregnant, and a blue flashing light may be used to indicate that a cow has an unusual reproductive status. Of course the light may be of any desired colour and may flash, be constantly lit, or remain unlit depending on the cow's reproductive status and the configuration of the device. The configuration of what lights are lit up, when, and whether or not the lights flash is programmed into the microprocessor. The light(s), such as LED(s), may be driven by a high current drive circuit 68 comprising a current amplifier circuit. A farmer is able to see and interpret these lights to understand the likely reproductive status of the cow to which the device is attached.

It should be appreciated that any suitable form of visual indication of a cow's reproductive status may be provided by the reproductive indication system.

### External Data Processing System

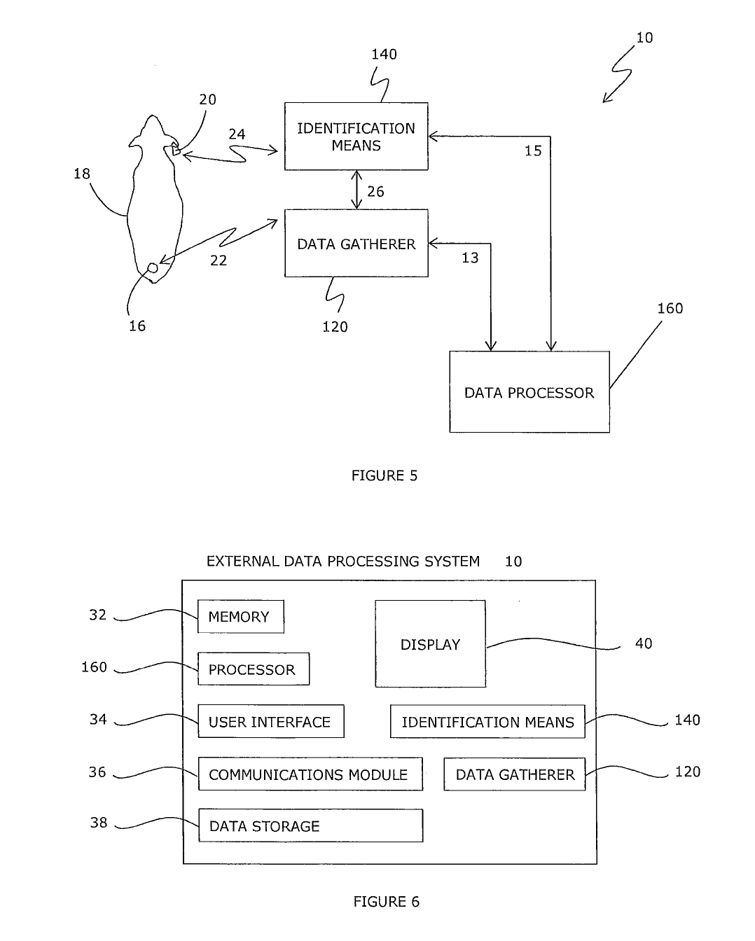

In another embodiment, as shown in FIGS. 5 and 6, the reproductive activity data is processed by an external data processing system that does not form part of the sensing device. In this embodiment, the reproductive activity data produced by the sensing device is received by an external data processing system comprising a data gatherer for receiving reproductive activity data from a sensing device, an identification means for identifying a cow, and a processor for executing software instructions.

In particular, the reproductive activity data is received by the data gatherer through wireless communication with the sensing device and is then provided to the processor for processing. Similarly, the identification data, relating to the cow to which the sensing device is attached, is received by the identification means and is then provided to the processor for processing.

Once the data is received by the external data processing system, the processor executes software that analyses the data according at least one preselected reproductive activity threshold and at least one time threshold to produce a determination as to the individual cow's reproductive status, as described above.

The data processor may be any suitable electronic hardware platform or system having a programmable processor that is able to carry out the reproductive status indication system processes. The data processor may, for example, comprise a computer, tablet, smart-phone or any other programmable electronic device for executing software, including a server or cloud-based system which is configured to directly or indirectly receive the reproductive activity data and cow identification data over a network from the data gatherer and identification means for processing.

As shown in FIGS. 5 and 6, one form of external data processing system comprises a data gatherer 120, a identification means 140, and a data processor 160. Typically, the external data processing system 10 also comprises a memory 32 for processing data, a user interface 34 (such as a keyboard, mouse, touchpad, or voice recognition system) for a user to interact with the data processing system, and a communication module 36 for communicating with the data gatherer 120 and identification means 140. The data processing system may also comprise other external devices or networks such as, the Internet or storage databases, one or more data storage mediums 38, such as a hard disk or hard drive (whether external or integrated), and an electronic display 40 (either integrated or associated with the data processing system) that is capable of displaying a graphical user interface.

The data gatherer is adapted to receive reproductive activity data stored on the sensing device. The data gatherer may either read the data on the sensing device through wireless communication or the sensing device may be configured to wirelessly transmit the data to the data gatherer.

Any suitable communication medium may be used to transfer reproductive activity data from the sensing device to the data gatherer. Typically, the sensing device comprises a communications module 36 for wirelessly communicating with a data gatherer. Any wireless communication module or transceiver using any wireless communication protocol may be used to communicate reproductive activity from the sensing device to a data gatherer.

In one form, where the device comprises one or more lights, such as LEDs, to provide a visual indication of a cow's reproductive status, the communications module may comprise an optically encoded data transmission system that enables the reproductive activity data to be encoded for reception and decoding by optical sensors provided in the data gatherer. Alternatively, the PCB for the sensing device may be provided with a dedicated optical data transmission LED or light source for transmitting the reproductive activity data to a data gatherer.

In another form, the sensing device comprises an infra-red transmitter that produces infra-red signals that indicate a cow's reproductive status and which are received by a compatible data gatherer.

In yet another form, as shown in FIG. 4, the sensing device comprises a communication module 36 comprising an RF transceiver 70 that is configured to transmit reproductive status data to a compatible data gatherer using an RF communication protocol.

Regardless of the type of communications module used by the sensing device, the communications module optionally comprises an internal memory 72 that can be accessed if the main battery power supply to the rest of the circuit has failed or worn out. This ensures that collected data is always retrievable via wireless communication.

The data gatherer 120 wirelessly communicates with the sensing device 200 on the cow 18 by receiving the reproductive activity data stored on the device 200 when the device is within range of the data gatherer.

The identification means is used to identify the cow from which the reproductive activity data is obtained. The identification means may be adapted to read cow identification data from an electronic identification device attached to the cow, or to receive identification data transmitted from an electronic identification device attached to the cow or from the sensing device itself. For example, in one form, the sensing device is programmable to store cow identification data. In particular, the device is programmed to store unique identification data relating to the cow to which the sensing device is or will be attached. The device is typically programmed at or around the time at which it is attached to a cow. Alternatively, the device may be provided with a unique device ID and the data processing system may maintain an electronic table that links each device ID with the cow identification data for the cow to which the device is attached. In this form, when the sensing device is within range of the identification means, the identification means reads the device to obtain the identification data of the cow to which the device is attached.

Alternatively or additionally, the identification means 140 wirelessly communicates with an electronic identification device 20 on the cow, for example an electronic ID ear tag, to receive or read data relating to the cow's identity when the cow is within range of the identification reader.

Either or both the data gatherer 120 and identification means 140 may send or transmit data to the sensing device 200, the electronic identification device 20, or both, to provide two-way data transmission. The data gatherer 120, the identification means 140, the sensing device 200, and the electronic identification device 20 may communicate with each other through wireless communication mediums 22, 24, 26, which may be any form of wireless communication medium such as, but not limited to, RF or RFID protocol, Bluetooth, infrared, optically encoded data transmission, or the like.

In a typical setup, both the data gatherer 120 and identification means 140 are located near a milking parlour at a location where each cow can pass the data gatherer 120 and identification reader 140 in single file upon entering or exiting the parlour. Alternatively, the system may be installed at drinking or feeding troughs, which is particularly useful when the system is used for beef cows, dairy heifers, or other bovines. In both embodiments, the data gatherer 120 and identification means 140 are located close to each other so that they can read or receive the reproductive activity data and cow ID data from a cow substantially simultaneously. In this way, the reproductive activity data can be linked to a particular cow at each read/upload, as will be explained in detail later.

In an alternative embodiment, where the cow identification data is stored on the sensing device, the data gatherer and identification means receive the respective data from the sensing device, either by reading the data from the device or by receiving the data transmitted by the device.

The identification means and data gatherer may be separate modules or they may be combined in a single module that is able to read or receive both reproductive activity data and cow identification data.

The data gatherer 120 and identification means 140 communicate the respective data to the data processor, either wirelessly or over a hardwired connection.

The data processor is programmed to execute a reproductive status indication software program that analyses reproductive activity data 13 and cow identification data 15 from the data gatherer and identification means to generate a determination of a cow's reproductive status and to cause the reproductive status indication system to provide a user, such as a farmer, with a visual indication of the cow's reproductive status.

The visual indication is determined based on an analysis of reproductive activity data in relation to a predetermined level of reproductive activity within a predetermined time period, as described above.

The reproductive activity threshold and time threshold are provided by data processing software executed by the data processing system and may be changed after each time that the data processing system determines that the cow is in oestrus. The data processing system may be reprogrammed via the user interface 34, but preferably the software automatically adjusts the thresholds.

The reproductive status indication software may be an independent program that communicates with conventional herd management software operating on the external data processing system. Alternatively, the reproductive status indication software executed by the external data processing system may be partially or entirely integrated with herd management software as an add-on or plug-in component.

The reproductive status indication system is able to link reproductive activity data with cow identification data to ensure that the reproductive status indication provided for a cow is based on an analysis of reproductive activity data relating to that cow only.

To help ensure that the reproductive status indication system links the reproductive activity data and status indication with the correct cow, the system may be configured so that a data gatherer 120 and identification means 140 are located close to each other at or near a milking parlour. When the cows line up for milking, each cow passes the data gatherer 120 and identification means 140 in single-file. The identification means 140 receives the cow identification data 24 from the electronic ear tag 20 or from the sensing device 200, as the case may be, at approximately the same time as the data gatherer 120 receives the reproductive activity data 22 from the sensing device 200. The data gatherer 120 and identification means 140 may communicate with each other to link the cow identification data to the reproductive activity data for subsequent processing by the data processing system. In this way, the reproductive status indication for a particular cow is determined by analysing the reproductive activity data associated with that cow. Alternatively, each data gatherer 120 and identification means 140 is configured to send its respective data to the data processing system and the data processing system creates the link between the cow identification data and the reproductive activity data based on the time at which the data was received by the data gatherer 120 and identification means 140.

Optionally, the reproductive status indication system is configured so that the cow identification data received by the identification means 140 is sent to the sensing device 200 at each data reading or upload session. The cow identification data may be sent to the sensing device 200 directly by the identification means 140 or indirectly via the data gatherer 120. The received cow identification data is then stored in the memory of the sensing device. This means that if the device 200 falls off the cow and is located in the paddock or elsewhere, the cow to which it was last attached may be identified and any stored reproductive activity data may be read from the device and associated with that identified cow.

In one form, the microprocessor of the sensing device is adapted to record the real time at which reproductive activity data was transmitted from or read from the sensing device and the time interval between when mounts or other reproductive activity occurred, including the start and finish time of each mount or other reproductive activity. The external data processing system 10 can, if desired, then back-calculate the time of day that each mount or other reproductive activity occurred, based on the real time at which the data was uploaded.

Optionally, the data processing system is configured to receive reproductive activity data for each cow in periodic batches. For example, a batch of reproductive activity data may be received each time the cow arrives at the milking parlour, which may be daily, twice daily or more. Alternatively, such as in the case of beef cows, dairy heifers, or other bovines, a batch of reproductive activity data may be received each time the cow approaches a drinking or feeding trough or wherever else a reproductive activity data reader is located.

Each batch of reproductive activity data that is received by the data gatherer includes all reproductive activity data sensed by the sensing device since the last batch of reproductive activity data was received.

When a batch of reproductive activity data for a cow is received by the data processing system, the data processing system analyses the data and makes a determination about the reproductive status of the cow. The data processing system then generates a visual indication of the cow's reproductive status and may also update existing reproductive status data for the cow.

The data processing system may output data that indicates a cow's reproductive status in various ways. The reproductive status indication is typically provided on a graphical user interface, such as a display 40, that is integral with or connected to the external data processing system, either wirelessly or through a hardwired connection. For example, the indications of reproductive status may be provided in a table that identifies each individual cow and its reproductive status at a set time period (such as the time at which the last indication was produced by the system) or over an extended time period, such as one month or longer. Typically, the reproductive status indication system can be configured so that the user is able to select and vary the way in which the data is displayed. Alternatively, the data may be sent to another system for display or may be received by other software such as herd management software, which then displays the reproductive status data.

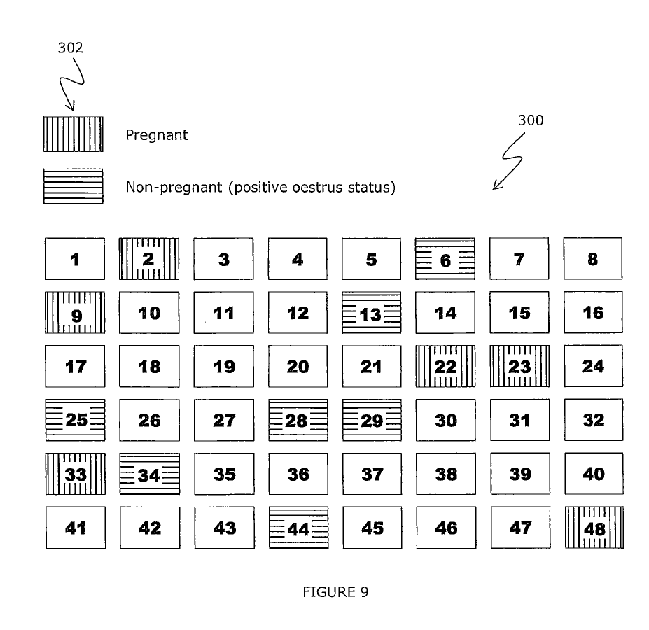

FIG. 9 shows an example of one possible graphical user interface (GUI) in which the cows in the herd are represented by an array 400 of numbered blocks, and where the reproductive status of each cow is graphically displayed on the block, e.g. as a pattern or colour coded relative to a key 402.

Alternatively or additionally, the data processing system may also be configured to send the reproductive status data back to the sensing device 200 on a cow after the data processing system makes a determination as to that cow's reproductive status. For example, the data gatherer 120 may be used to communicate the reproductive status determination data to the sensing device. The sensing device, upon receiving the determination data from the data processing system, then provides a visual indication of the cow's reproductive status, such as using one or more lights, such as LEDs, as described above, or by using any other suitable form of visual indication.

### Breeding Event Indicator

Regardless of the form of data processing system used, the reproductive status indication system may also comprise a visual breeding event indicator that indicates whether the cow has undergone a breeding event, such as artificial insemination or insemination by bull, within a predetermined time period. Typically, the breeding event indicator is adapted to indicate whether the cow was inseminated when she was last in oestrus. In another form, the breeding event indicator is adapted to indicate whether the cow has been inseminated within a certain time period, such as the last 28 days, for example. The breeding event indicator may be used to sort cows that have been bred from those that have not.

In one form, the breeding event indicator 81 is a visual indication provided on the device, such as a light, LED, or other form of visual display, as shown in FIG. 4.

The breeding event indicator is typically controlled by the microprocessor and is activated based on input data relating to the cow's breeding event status, i.e. whether the cow has been ‘bred’ or ‘not-bred’.

In one form, input data relating to a cow's breeding event status may be input manually to the sensing device via an input data system having an interface on the device. For example, the input data interface may be a switch that toggles the breeding event status of the cow. Alternatively, the detection assembly may be configured to provide an input data interface. For example, the farmer may toggle the breeding event status of the cow by manually triggering the detection assembly according to a predetermined input pattern, which can be detected by the microprocessor and used to update the breeding event indicator. For example, one long activation of the sensor of the detection assembly (such as one long press of the sensor) followed by five short activations (such as five short presses) may toggle the breeding event status between ‘bred’ and ‘not-bred’.

Alternatively or additionally, the input data may be transmitted to the device automatically by an input data system that is separate from the sensing device. In one form, the separate input data system forms part of an external data processing system, as described above, in which breeding event status data is input to the data processing system through its user interface. The external data processing system may be configured to monitor data relating to the breeding event status of each cow and to send updated breeding event status data to the sensing device of each cow via the data gatherer. Alternatively, any other suitable input data system may be used for transmitting input data to the sensing device, either wirelessly or through a hardwired connection.

Alternatively or additionally, the breeding event status indication may be a visual indication provided on a graphical user interface that is external to the sensing device and may or may not be integrated with or in communication with an external data processing system.

The input data system may be either integrated with or in communication with herd management software that records breeding event information for each cow as it occurs.

By identifying cows that have been bred, the farmer is able to use the reproductive status indication system to provide an early indication of which of these cows is likely to be pregnant or not.

### Visual Alert Relating to Abnormal Reproductive Status

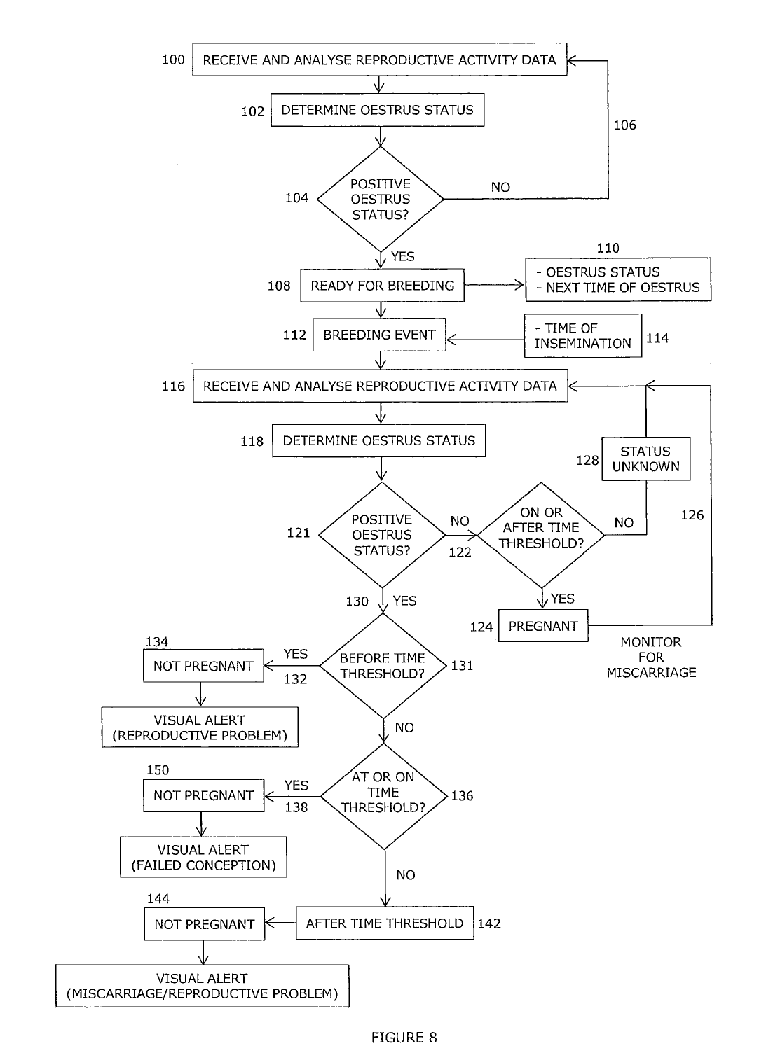

In one form of the invention, as shown in FIG. 8, where a cow is exhibiting abnormal reproductive activity, the reproductive status indication system is configured to provide a visual alert 134 to the farmer. In one embodiment, the visual alert may also be used to indicate a failed conception after a breeding event. Alternatively, or additionally, a visual alert is used to indicate that the cow is exhibiting abnormal patterns of reproductive status, which may suggest that she has reproductive problems. Optionally, the visual alert is configured to indicate the type of reproductive problem that may be suffered by the cow. For example, the alert may indicate that she has a short oestrus cycle; that she may have a reproductive problem, such as poly-cystic ovaries; that she is anoestrus and is not entering into oestrus; or that she may have miscarried. In one form, the visual alert is generated based on the time at which the cow was last detected as being in oestrus relative to a time threshold, which typically represents the expected time of next oestrus following a breeding event, and may also be based on previous reproductive status determinations for the cow, particularly the most recent determinations. Alternatively or additionally, the alert is generated if the system does not detect that the cow is in oestrus within a predetermined time period, such as 50 days for example.

For example, in one embodiment, if the reproductive status indication system detects that a cow is in oestrus after a breeding event and well prior to the time of her next expected oestrus, the system generates a reproductive status indication of non-pregnant and also provides a visual alert that indicates that the cow may have a reproductive problem and/or that she is short cycling. In another example, if the reproductive status indication system detects a positive oestrus status after a breeding event and on or around the time threshold (for example, on or around the time of a cow's next expected oestrus or on or around a time which may be any time prior to the expected birth), the system generates a reproductive status indication of non-pregnant. In another example, if the reproductive status indication system detects a positive oestrus status after previously determining that the cow has a reproductive status of pregnant (i.e. after the time threshold of the cow's next expected oestrus), the system generates an updated reproductive status indication of non-pregnant and provides a visual alert that indicates a miscarriage.

The visual alert may simply be an alert to the user that the cow has an abnormal reproductive status, or the alert may indicate whether the cow is short cycling, anoestrus, has miscarried, or has some other reproductive problem. The alert may be provided on the sensing device as a visual indication, such as one or more lights, LEDs, or another suitable visual display. Alternatively, the alert data may be communicated to a separate device having a graphical user interface for displaying the alert to the user. Optionally, the cow's previously recorded reproductive status over a predetermined time period may also be provided on the graphical user interface so that the user can analyse the cow's reproductive status patterns over time.

### Use of Secondary Reproductive Activity Data to Determine Reproductive Status

In one embodiment, the data processing system is configured to receive and process secondary reproductive activity data from other devices to determine the reproductive status of a cow. The secondary data is received and processed in addition to receiving and processing the reproductive activity data from the sensing device.

Examples of possible secondary data that may be used include the following:
1. Milking order changes. I.e. changes to the sequence in which cows enter the dairy parlour. Cows in heat often lead or trail, rather than fall in to their normal order.
2. Changes in pedometry (e.g. via activity based monitors on the cow).
3. Changes in rumination time (e.g. via accelerometer based devices on the cow).
4. Changes in sitting & standing (e.g. via accelerometer based devices on the cow).
5. Changes in body temperature (such as the internal, external, and/or milk temperature of the cow).
6. Hormone changes (especially changes in progesterone, oestradiol, pregnancy associated glycoproteins, and/or luteinizing hormone).
7. Milk yield changes. (e.g. data via inline yield monitoring devices). The milk yield of cows in oestrus typically drops 25% and is made up after oestrus.
8. Milk composition changes (e.g. where mounting activity, where a cow is mounted by another cow or bull, is combined with milk changes, there is a higher likelihood that the cow is in oestrus, pregnant, or non-pregnant, as the case may be).
9. Electrical impedance changes of vaginal mucus.

3. Determination of a Cow's Reproductive Status

The reproductive status indication for a cow may be updated by the data processing system each time the system analyses the reproductive activity for the cow, which optionally includes any secondary reproductive data activity, and makes a determination as to the cow's reproductive status. This determination is made each time new reproductive activity data is received, either as a batch of data or not. Typically, the determination is made at least daily. For example, where an external data processing system is used, a determination of a cow's reproductive status may be made during daily milking or feeding or drinking at troughs, when data is collected from the sensing device on the cow.

### Control of Drafting Gates

Optionally, the reproductive status indication system is configured to communicate with and control one or more mechanical drafting gates on a farm, based on the reproductive status indication for each cow. In this form, the data processing system is connected, either wirelessly or via hardwiring, to a control system or systems of one or more mechanical drafting gates situated on the farm. For example, the data processing system may be configured to generate control signals for, directly or indirectly, controlling the position of one or more mechanical drafting gates to sort cows into particular holding pens, paddocks, or to otherwise sort the cows based on their respective reproductive status indication of pregnant, non-pregnant, or undetermined, and optionally based on any visual alert that indicates that a cow might have reproductive problems.

For example, the data processing system may be configured to control one or more drafting gates according to any one or more of the following scenarios:
1. Cows in oestrus/not pregnant after a breeding event (status 150 in FIG. 8)—because of a return to oestrus, these cows may be automatically drafted into a holding pen for artificial insemination or drafted to be run with a bull.
2. Cows having a reproductive status indication of pregnant (status 124 in FIG. 8)—may be automatically drafted to a pen/paddock separate to non-pregnant cows.
3. Cows that have shown irregular heat cycles and have a reproductive status indication of not pregnant (status 134 in FIG. 8)—may be automatically drafted into a pen for vet attention.
4. Cows that had a reproductive status indication of pregnant but miscarried and returned to having a reproductive status of in oestrus (status 144 in FIG. 8)—may be automatically drafted for the attention of a vet/and or insemination.
   The above scenarios are indicative only, and it will be appreciated the automatic drafting decision may be as simple or complex as desired depending on the desired level of automation required and the nature or style of farm management for the particular farm.

4. Operation of the Reproductive Status Indication System

The operation of the reproductive status indication system will now be described in further detail with reference to FIGS. 8 to 10.

### Detecting When a Cow is in Oestrus and Ready for Breeding

Referring to FIG. 8, the data processing system monitors the reproductive activity data 100 of a cow and makes a determination as to whether a cow is in oestrus 102 based on the analysed reproductive activity data. The determination of the oestrus status of the cow is based on the extent of reproductive activity associated with that cow within a certain time interval. In particular, and as mentioned above, the data processing system is programmed to provide a reproductive status indication that a cow is in oestrus if the reproductive activity data satisfies one or more predetermined reproductive activity thresholds and one or more predetermined time periods.

Because the sensor of the sensing device 200 may be activated in response to non-mounting activity such as bumps, the data processing system may be adapted to filter out such data based on the duration of the sensor activation signals and/or the isolation of the activation signals, i.e. if a signal is not within a cluster of activation signals, which is typical of true reproductive activity, the data may be filtered out.

The data processing system makes a determination 104 as to whether a positive oestrus status is detected. If the oestrus status is negative (i.e. the cow is considered not to be in oestrus), the data processing system provides a corresponding indication of the cow's reproductive status and awaits the next batch of reproductive activity data 106. The data processing system may provide supplementary data relating to the cow's reproductive status also. For example, if the data processing system determines that the cow is in oestrus and ready for breeding 108, the system provides a reproductive status indication that the cow is in oestrus 110 and may also output supplementary data, which may include a calculated or predicted time of the cow's next oestrus cycle. This data may be used to configure the time threshold used in determining the cow's reproductive status subsequent to breeding, as will be explained later.

In one form, if, after monitoring one or more oestrus cycles of a cow, the data processing system has repeatedly determined that the cow is not in oestrus but has exhibited levels of reproductive activity that could correspond to oestrus activity, but that are below the existing reproductive activity and time thresholds used by the software, the software may determine that the cow is exhibiting low reproductive activity (i.e. that she has a quiet heat) and may automatically change the at least one predetermined reproductive activity threshold and/or the at least one predetermined time threshold to better identify when she is in oestrus. In this way, there is less risk that a cow showing a quiet heat could receive a false indication that she is pregnant.

### Breeding Event

The reproductive status indication that a cow is in oestrus 110 may be presented to a user of the system via a visual indication provided on the sensing device and/or via a graphical user interface on a display associated with an external data processing system or via a graphical user interface of another electronic device such as a computer, smartphone or tablet after the reproductive status determination has been received by the electronic device either from the sensing device or from an external data processing system (depending on the data processing system used) over a communications network, either directly or indirectly. The cow may then be automatically drafted or manually drafted for breeding in response to the indication of her positive oestrus status.

After a breeding event 112, such as artificial insemination or insemination of a cow by a bull, the data processing system is optionally configured to receive input data 114 that the cow has been subjected to a breeding event. The input data 114 may include the time of insemination, for example. Additionally or alternatively, the input data 114 may generate a signal to the data processing system to begin monitoring the reproductive status of the cow because a breeding event has occurred.

Optionally, as described above, the system also provides a breeding event indicator that indicates that the cow has been bred within a predetermined time period.

### Reproductive Status Monitoring to Indicate Pregnancy and Oestrus Status

As shown in FIG. 8, the data processing system monitors the reproductive status of a cow following a breeding event for that cow. After a breeding event for a cow, the data processing system receives reproductive activity data either regularly, as the data is produced by the detection assembly, or in batches (e.g. daily, twice daily or more frequently). The data processing system analyses the reproductive activity data according to at least one reproductive activity threshold and at least one time threshold and produces a determination as to whether the cow's reproductive status is: pregnant or non-pregnant. In one embodiment, the data processing system is also configured to produce a determination that a cow's reproductive status is undetermined if the cow's reproductive status is analysed after a breeding event but before the time of her next expected oestrus. The determination of pregnant, non-pregnant, or undetermined is based on whether or not the data processing system determines that the cow is in oestrus within a preselected time period, which is typically the time of her nest expected oestrus or a time subsequent to the time of her next expected oestrus if she does not conceive.

The time threshold may be relative to a reference time or it may be provided in real time. The time threshold is calculated based on a time period representing the typical oestrus cycle of a cow. For example, the time period may be set to be in the range of 20-24 days for a normal cycling cow. The time threshold is typically a number of days relative to a reference time or event, such as the time of oestrus prior to breeding, or the threshold may be a real time date. For example, where the time threshold is a real time threshold, a determination is made as to whether or not a cow is in oestrus before, say, 20 Jul. 2014, which is the time when the cow is next expected to be in oestrus (plus a small buffer time period, which may be an additional two days for example) if breeding is unsuccessful.

In another example, where the time threshold is calculated relative to a reference time, such as the time of the breeding event or the time at which the cow was in oestrus prior to the breeding event, the time threshold may be 26 days since the cow was inseminated or since the last time that the cow was in oestrus.

After inseminating a cow having a reproductive status indication of being in oestrus 118, the reproductive status indication system monitors the cow's reproductive activity and makes a determination 121 about whether the cow has returned to oestrus. If a determination is made that the cow is not in oestrus 122, the data processing system compares the time of this determination with the predetermined time threshold (typically representing the time of the next expected oestrus and optionally including a buffer). If the determination that the cow is not in oestrus is made on or after the time threshold, the system generates a reproductive status indication for the cow of ‘pregnant’ 124. The data processing system is configured to monitor subsequent reproductive activity data 126 for a predetermined time period (such as 70 days, for example) to detect any change in the cow's reproductive status, e.g. due to a miscarriage or due to a false indication that the cow was pregnant. In one embodiment, the system is adapted to generate a reproductive status indication of ‘undetermined’ 128 if a determination that the cow is not in oestrus is made before the time threshold, e.g. before the next expected oestrus. This is because the system of the invention may require the cow to be monitored for at least 20 to 24 days before it can provide a reasonably reliable indication of whether or not the cow is pregnant.

If the data processing system makes a determination that the cow is in oestrus 130 on or near the time threshold after a breeding event, the data processing system generates a reproductive status indication of ‘non-pregnant’.

The data processing system is optionally configured to cause the reproductive status indication system to provide a visual alert associated with a non-pregnant reproductive status. In one form, the alert is generated based on a comparison between the time at which the cow was considered to be in oestrus 130 relative to the predetermined time threshold 132 (typically representing the time of next expected oestrus). The alert may simply be an alert that the cow has an abnormal pattern of reproductive status and may therefore be suffering from a reproductive problem and/or the alert may be configured to provide further information that indicates the type of reproductive problem that the cow may be suffering from. In this embodiment, if the data processing system determines that the cow is in oestrus 131 before the time threshold 132, the data processing system updates the reproductive status indication to ‘non-pregnant’ and causes the reproductive status indication system to generate a visual alert 134 that indicates that the cow has an abnormal reproductive status, which then needs to be investigated by the user, and/or the alert may provide more detailed information, such as an indication that the cow has a short oestrus cycle or possible ovarian cysts. If the data processing system makes a determination 136 that the cow is in oestrus at or on the time threshold 138, the data processing system updates the reproductive status to ‘non-pregnant’ and may optionally generate a visual alert or supplementary data 150 that indicates an unsuccessful insemination. If the data processing system makes a determination 142 that the cow is in oestrus after the time threshold, and if a previous reproductive status indication of pregnant has been generated, the data processing system updates the reproductive status to ‘non-pregnant’ and generates a visual alert 144 that indicates that the cow has an abnormal reproductive status and/or that indicates that the cow has miscarried.

Additionally or alternatively, the reproductive status indication system may be configured to generate an alert after a cow fails to enter into oestrus after a predetermined time period and before a breeding event. For example, if the system monitors the oestrus status of a cow for, say, 60 days and the system does not produce a determination that the cow has entered into oestrus within this time period, the system may generate a visual alert that the cow has an abnormal reproductive status. Optionally, the system is configured so that the visual alert indicates that the cow is non-cycling.

As mentioned above, the visual alert may be provided on the sensing device and/or on a graphical user interface of another device. Optionally, the system is adapted so that the user can program when a visual alert should be generated for a particular circumstance and/or whether the alert should provide an indication of the likely reproductive problem suffered by the cow.

It will be appreciated that it is not necessary for the reproductive status indication system to provide a constant indication of a cow's reproductive status. For example, in some embodiments, the system generates an indication of a cow's reproductive status only when particular determinations are made by the data processing system, such as upon first determining a pregnancy, or first determining a non-pregnancy, or upon determining a change to non-pregnant after a previous determination of pregnant as a result of a miscarriage for example.

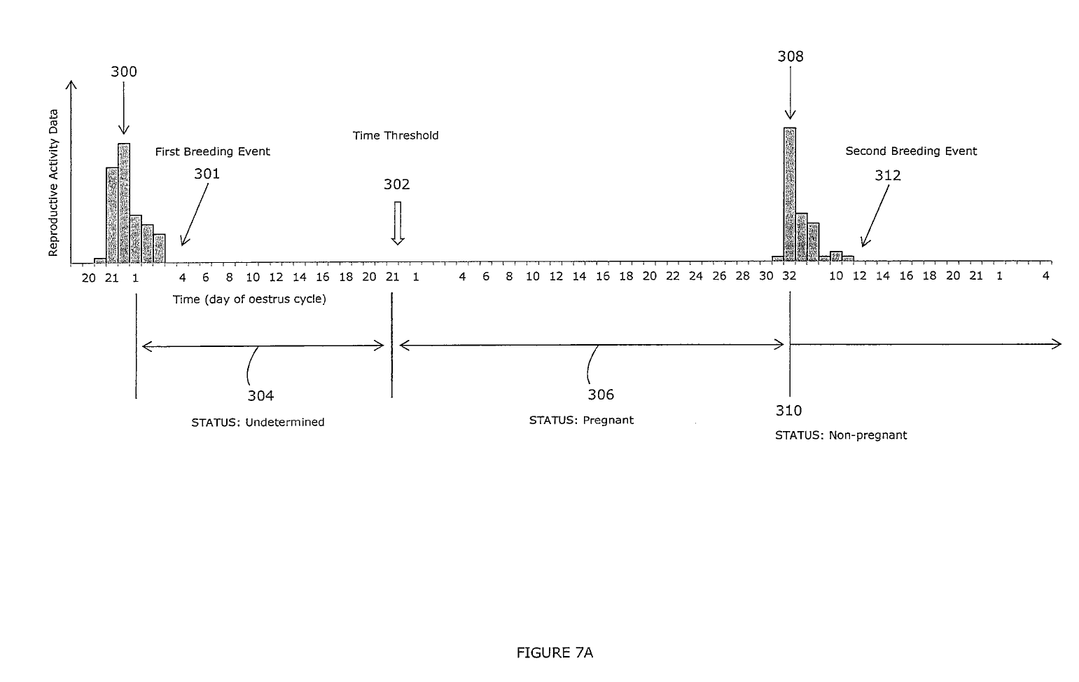

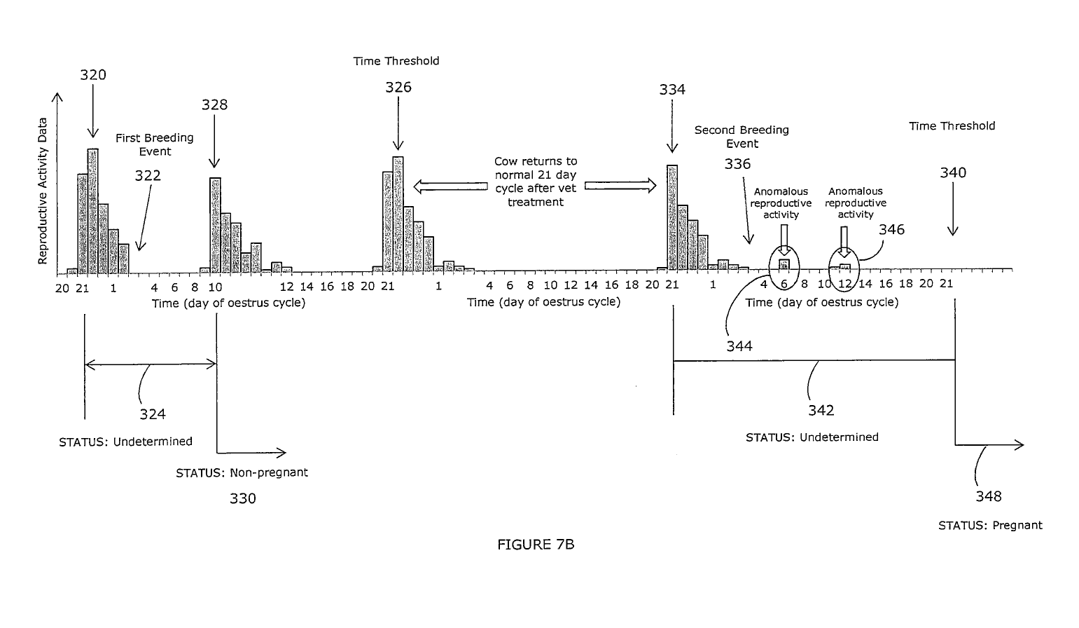

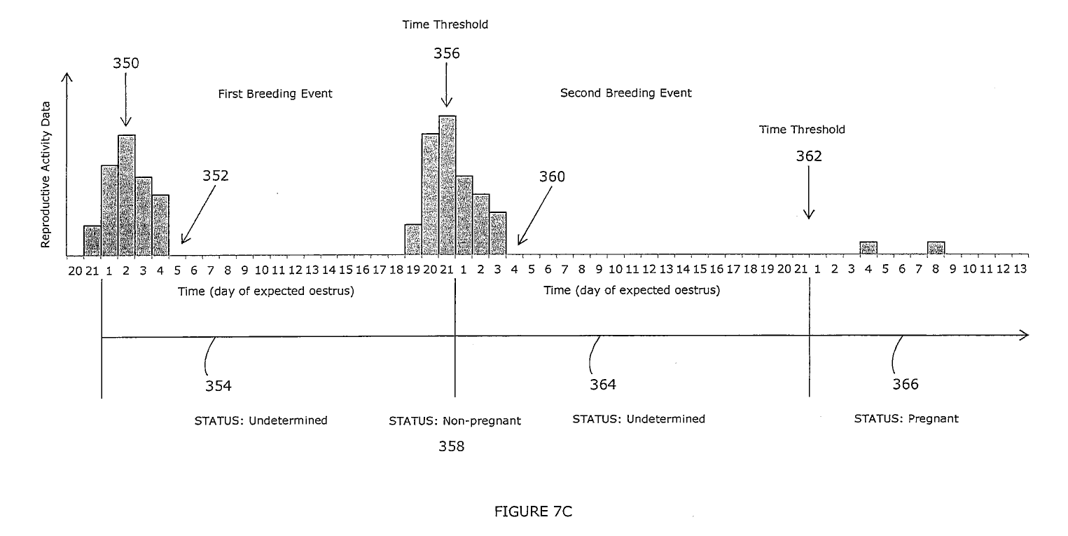

Various example scenarios that can be automatically detected by the reproductive status indication system will now be described with reference to FIGS. 7a-7c.

### EXAMPLE SCENARIO 1

### Cow Pregnant, but Subsequent Miscarriage

Referring to FIG. 7A, the data processing system determines that the cow has a positive oestrus status based on a cluster of reproductive activity data 300. Data that indicates that a cow has positive oestrus status is output from the reproductive status indication system and results in the cow being drafted for a first breeding event 301. The time threshold 302 for determining the reproductive status of the cow is the time of its next expected oestrus, for example based on the typical oestrus cycle frequency such as 21 days from the previous oestrus. In this example scenario, a negative oestrus status is determined for each batch of reproductive activity data over the time period indicated at 304 prior to the predetermined time threshold 302. The system outputs a reproductive status indication of undetermined during this period 304. At or on the time threshold, the determined oestrus status is still negative. Therefore, the system generates a reproductive status indication of ‘pregnant’. This status is maintained after the time threshold and continues for the time period indicated at 306 while the reproductive activity data continues to indicate a negative oestrus status. However, some time into the pregnancy, the data processing system detects a positive oestrus status based on a cluster of mounting activity indicated at 308. The positive oestrus status may be due to a miscarriage. The data processing system causes the reproductive status indication system to update the reproductive status indication for the cow to ‘non-pregnant’, as shown at 310. The cow can then be returned for another round of insemination in a second breeding event 312 that occurs in that new oestrus cycle.

### EXAMPLE SCENARIO 2

### Cow with Possible Reproductive Problems

Referring to FIG. 7B, the system detects the cow as having a positive oestrus status, due to the reproductive activity at 320, and the cow is submitted for a first breeding event 322. In the time period 324 that follows, a negative oestrus status is detected and the system outputs a pregnancy indication status of ‘undetermined’ because it is before the calculated time threshold 326 representing the time of the next expected oestrus. However, the reproductive activity data 328 indicates that the cow returns to oestrus on day 10, well prior to the time threshold. A short oestrus cycle is typically indicative of reproductive problems such as ovarian cysts and therefore the system outputs a new reproductive status indication of ‘non-pregnant’, as shown at 330, and may also output a visual alert indicating that the cow may have reproductive problems and should be seen by a vet. As a result of vet treatment, the cow returns to a normal 21 day oestrus cycle, as shown by the successive positive oestrus statuses detected at 332 and 334. The cow can then be resubmitted for a second breeding event 336 and a new time threshold, representing the time of the next expected oestrus, is calculated at 340. During the time period from the second breeding event 336 to the time threshold 340, the reproductive status is indicated as ‘undetermined’, as shown at 342, because the oestrus status is detected as being negative over this period. In this example, anomalous reproductive activity is detected at 344 and 346, for example due to bumps, and may be filtered out, i.e. it is not indicative of a return to oestrus. The negative oestrus status is maintained at the time threshold 340 and the system updates the reproductive status indication status to ‘pregnant’, as shown at 348.

### EXAMPLE SCENARIO 3

### Cow Redrafted for 2^{nd} Breeding After 1^{st} Breeding Fails

Referring to FIG. 7c, the system detects the cow is in positive oestrus at 350 based on the reproductive activity data and the cow is submitted for a first breeding event 352. A negative oestrus status is detected in the time period 354 between the breeding event and the time threshold 356, representing the time of the next expected oestrus, and the reproductive status is output as ‘undetermined’. However, on or around the time threshold 356, the cow is detected as returning to oestrus and its reproductive status is updated to ‘non-pregnant’, as indicated at 358. As the first breeding event failed, the cow can be immediately and automatically submitted for a second breeding event 360 in the current oestrus cycle. A new time threshold 362, representing the time of the next oestrus, is then calculated and used by the data processing system. In this example, the system maintains a reproductive status of ‘undetermined’ in the time period indicated at 364, prior to the time threshold 362, as a negative oestrus status is maintained during this time period. The reproductive status is then updated to ‘pregnant’ 366 once the time threshold 362 is reached, due to the maintained negative oestrus status. In this example, anomalous mounting data 368 (not indicative of reproductive activity) is detected and filtered out as in example scenario 2.

In all embodiments, the data processing system may be reset to vary the visual indication provided by the reproductive status indication system. For example, where the reproductive status indication system has been found to provide a false indication that a cow is non-pregnant and the cow is subsequently found to be pregnant, the data processing system may be reset to produce a determination that the cow is pregnant and to cause the reproductive status indication system to provide a corresponding visual indication of the cow's reproductive status.

It should be appreciated too that in its most comprehensive form, the reproductive status indication system of the invention is able to provide a visual indication as to whether a cow is in oestrus, not in oestrus, pregnant, non-pregnant, or has an undetermined reproductive status. In other forms, a more basic form of the system may be used to only identify whether a cow is in oestrus or not. Alternatively, the system may be used to only identify whether a cow is pregnant or not. Optionally, in this form, the system may also be configured to identify whether a cow's reproductive status is undetermined following a breeding event.

5. General

Embodiments of the invention may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the foregoing, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, and/or various other mediums capable of storing, containing or carrying instruction(s) and/or data.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or software algorithms described in connection with the examples disclosed herein may be embodied directly in hardware, in a software module executable by a processor, or in a combination of both, in the form of a processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated in the figures may be rearranged and/or combined into a single component or embodied in several components without departing from the invention. Additional elements or components may also be added without departing from the invention. Additionally, the features described herein may be implemented in software, hardware, as a business method, and/or combination thereof.

In its various aspects, the invention can be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

The foregoing description of the invention includes preferred forms thereof. Modifications may be made thereto without departing from the scope of the invention.

1. A reproductive status indication system for generating an indication of a female bovine's reproductive status, the system comprising:
an electronic sensing device for locating on a bovine, the device comprising a detection assembly that is adapted to detect reproductive activity or absence of activity associated with the bovine and to produce reproductive activity data relating to the reproductive activity; and
a data processing system configured to receive reproductive activity data and analyse the reproductive activity data with respect to at least one predetermined reproductive activity threshold and at least one predetermined time threshold and to determine the bovine's reproductive status based on the analysis of the reproductive activity data;
wherein the reproductive status indication system is adapted to provide a visual indication of whether or not the bovine is pregnant after the bovine has undergone a breeding event, the visual indication being provided at or subsequent to the time at which the bovine is next expected to be in oestrus if she does not conceive, and wherein the visual indication provided is based on the determination produced by the data processing system.

2. The reproductive status indication system of claim 1, wherein the reproductive status indication system is also adapted to provide a visual indication of whether or not the bovine has an undetermined reproductive status after the bovine has undergone the breeding event and before the time period in which the bovine is next expected to be in oestrus.

3. The reproductive status indication system of claim 1, wherein the data processing system analyses the reproductive activity data using data processing software configured to automatically change the at least one predetermined reproductive activity threshold and/or the at least one predetermined time threshold after the data processing system determines that the cow is in oestrus.

4. The reproductive status indication system of claim 1, wherein the data processing system analyses the reproductive activity data using data processing software configured to automatically decrease the at least one predetermined reproductive activity threshold and/or the at least one predetermined time threshold after the data processing system determines that the cow is exhibiting low reproductive activity analogous to quiet oestrus.

5. The reproductive status indication system of claim 1, wherein the reproductive status indication system is also adapted to provide a visual indication of whether or not the bovine is in oestrus.

6. The reproductive status indication system of claim 1, and further comprising a breeding event indicator to indicate whether or not the bovine has been inseminated within a predetermined time period.

7. The reproductive status indication system of claim 1, wherein the data processing system is adapted to receive secondary data from one or more other devices, wherein the secondary data is indicative of whether the bovine is in oestrus or not.

8. The reproductive status indication system of claim 1, wherein the reproductive status indication system is adapted to provide a visual alert that indicates that the bovine has a reproductive problem.

9. The reproductive status indication system of claim 8, wherein the visual alert may indicate any of the following reproductive problems: that the bovine has an abnormally short oestrus cycle; that the bovine has poly-cystic ovaries; that the bovine is anoestrus; or that the bovine has conceived but has then miscarried.

10. The reproductive status indication system of claim 1, wherein the sensing device is adapted to detect both behavioural indicators of reproductive activity and physiological indicators of reproductive activity.

11. The reproductive status indication system of claim 10, wherein the sensing device comprises an accelerometer.

12. The reproductive status indication system of claim 1, wherein the data processing system is adapted to disregard any false reproductive activity data, such as bumps.

13. The reproductive status indication system of claim 1, wherein the reproductive status indication system is adapted to measure the time and duration of reproductive activity and/or to identify patterns of data correlated with reproductive activity.

14. The reproductive status indication system of claim 1, wherein the sensing device is adapted to provide a visual indication of the bovine's reproductive status.

15. The reproductive status indication system of claim 14, wherein the sensing device comprises one or more lights that are adapted to provide the visual indication of the bovine's reproductive status by being any two or more of the following: lit, unlit, flashing, and changing colour.

16. The reproductive status indication system of claim 1, wherein the data processing system is an external data processing system separate to the sensing device and further comprising:
a data gatherer for receiving the reproductive activity data from the sensing device;
a bovine identification data reader for reading identification data associated with the bovine; and
a data processor configured to:
receive and analyse the reproductive activity data from the data gatherer with respect to the predetermined reproductive activity threshold and the predetermined time threshold;
receive identification data for the bovine from the bovine identification data reader; and
determine the bovine's reproductive status based on the analysis of the reproductive activity data.

17. The reproductive status indication system of claim 1, wherein the reproductive status indication system is adapted to communicate with and control mechanical drafting gates for sorting bovines having a different reproductive status.

18. The reproductive status indication system of claim 1, wherein the bovine is a cow.

19. A method of providing a visual indication of a bovine's reproductive status, the method carried out by a reproductive status indication system and comprising:
placing an electronic sensing device on a bovine to detect reproductive activity associated with the bovine;
producing reproductive activity data based on the detected reproductive activity;
providing a data processing system to receive reproductive activity data from the sensing device;
analysing the reproductive activity data to determine the reproductive status of the bovine; and
providing a visual indication of whether or not the bovine is pregnant after the bovine has undergone a breeding event, the visual indication being provided at or subsequent to the time at which the bovine is next expected to be in oestrus if she does not conceive, and wherein the visual indication provided is based on the determination produced by the data processing system.

20. The method of claim 19 and further comprising the step of providing secondary data relating to the bovine's reproductive status to the data processing system, wherein the data processing system analyses the reproductive activity data and the secondary data to determine the reproductive status of the bovine.

21. The method of claim 19, further comprising the step of generating a visual alert if the reproductive activity data, over a predetermined time period, indicates that the bovine has abnormal reproductive status.

22. The method of claim 21, wherein the visual alert is generated if the reproductive activity data shows that:
(a) the bovine has an abnormally short oestrus cycle;
(b) the bovine is anoestrus and does not come into oestrus within the predetermined time period; or
(c) within the predetermined time period, the reproductive status indication system provided an indication that the bovine was pregnant and then subsequently provided an indication that the bovine is non-pregnant due to miscarriage.

23. The method of claim 19, wherein the bovine is a cow.

24. A reproductive status indication system for generating an indication of a female bovine's reproductive status, the system comprising:
an electronic sensing device for locating on a bovine, the device comprising a detection assembly that is adapted to detect reproductive activity or absence of activity associated with the bovine and to produce reproductive activity data relating to the reproductive activity; and
a data processing system configured to receive the reproductive activity data and analyse the reproductive activity data with respect to at least one predetermined reproductive activity threshold and at least one predetermined time threshold and to determine the bovine's reproductive status based on the analysis of the reproductive activity data;
wherein the reproductive status indication system is adapted to provide a visual indication of whether or not the bovine is in oestrus or not, wherein the visual indication provided is based on the determination produced by the data processing system; and
wherein the reproductive status indication system is adapted to provide a visual alert that indicates that the bovine has a reproductive problem.
